(19) United States
(12) Patent Application Publication
(10) Pub. No.: US 2010/0254151 A1
(43) Pub. Date: Oct. 7, 2010

(54) HEADLIGHT FIXTURE FOR MOTOR VEHICLES

(75) Inventor: Ralf PETER, Bad Berleburg (DE)

Correspondence Address: BIRCH STEWART KOLASCH & BIRCH, PO BOX 747, FALLS CHURCH, VA, 22040-0747, US

(73) Assignee: Ejot GmbH & Co., KG, Bad Berleburg (DE)

(21) Appl. No.: 12/748,087

(22) Filed: Mar. 26, 2010

(30) Foreign Application Priority Data
Mar. 27, 2009 (DE) 20 2009 004 351.7

(51) Int. Cl. F21V 21/14

(52) U.S. Cl. 362/528

(57) ABSTRACT

Headlight fixture for motor vehicles having an adjustment device includes a ball joint having a spherical head for selective headlight adjustment and a spherical seat held in a wall which seat is provided for inserting the spherical head with expandable slots. The spherical seat includes, at the one hand, a diameter which fits into a through hole in the wall and, on the other hand, is provided with two juxtaposed protrusions which fit into corresponding recesses at the through hole and seat themselves behind the wall upon rotation of the inserted spherical seat and, thereby, avoid the removal of the spherical seat from the wall.

The invention relates to a headlight fixture for motor vehicles having an adjustment device comprising a ball joint having a spherical head for a selective adjustment of the headlight and a spherical seat supported in a wall which seat is provided with an expandable slot for inserting the spherical head.

Such an arrangement is shown and described in DE 103 42 634 A1. For a safe mounting of a spherical seat provided for inserting the spherical head, the spherical seat is provided in the known headlight fixture with snap arms which are arranged in a slot of the spherical seat and which snap into place behind a wall upon insertion of the spherical seat and which, thereby, provide a snapping fixture for the spherical seat.

It is an object of the invention to conFigure the above mentioned headlight fixed such that, at the one hand, its mounting in a through hole of the wall maybe achieved in a simple way and which, at the same time, effects securing the spherical head in the spherical seat. This is achieved, according to the invention, thereby, that the spherical seat, at the one hand, comprises a diameter which fits into the through hole in the wall and which, on the other hand, is provided with two juxtaposed protrusions which fit into corresponding recesses at the through hole and which rest behind the wall upon rotation of the inserted spherical seat and, thereby, prevent removal of the spherical seat from the wall.

By means of the protrusions provided at the spherical seat which protrusion fit into corresponding recesses at the through hole in the wall, the spherical seat with inserted spherical head may by easily inserted into the through hole in order to be rotated therein with respect to the wall, where the protrusion come to rest at the back side of the wall, and thereby, hold the spherical seat and the complete ball joint on the wall, whereby the diameter of the through hole is adapted to the diameter of the spherical seat such that a subsequent widening of the spherical seat from the through hole is prevented which fittingly surrounds the spherical seat such that it cannot be widened anymore which prevents the spherical head to subsequently fall out or be removed of from the spherical seat. Therefore, by means of this arrangement, with the rotation of the spherical seat with inserted spherical head, two things are achieved at the same time, i.e., at the one hand, the secure mounting of the spherical seat and, thereby, of the ball joint at the wall and, on the hand, the maintaining of the spherical head in the spherical seat which otherwise would have be widened accordingly for taking out the spherical head. This widening is avoided by the circumferential engagement of the spherical seat in the though hole of the wall, whereby, with one single manipulation, the spherical seat and, thereby, the headlight fixture is fixed to the wall and, at the same time, is secured against falling out.

An embodiment of the invention is shown in the Figures.

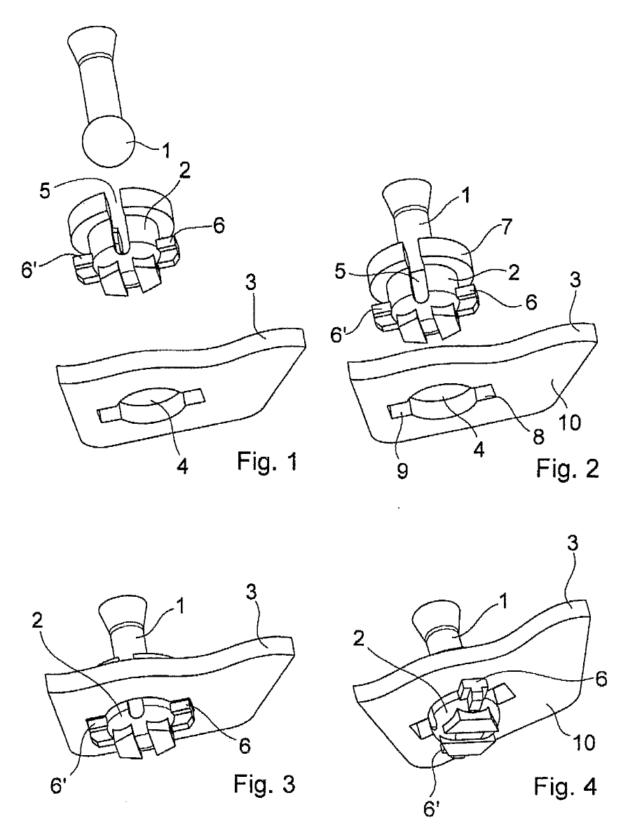

FIG. 1 shows the spherical head initially taken out of the spherical seat, the spherical seat itself and, additionally, the wall with the through hole;

FIG. 2 shows the mating of the spherical head and the spherical seat in the stage of being mounted in which the ball joint conFigured in this way, is held spaced apart from the wall at first;

FIG. 3 shows the ball joint as inserted into the through hole of the wall; and

FIG. 4 shows the ball joint rotated with respect to the position in FIG. 3.

In FIG. 1, the three essential elements of the invention, i.e. the spherical head 1, the spherical seat 2 and a part of the wall 3 with the through hole 4 are shown.

FIG. 2 shows the mated parts, i.e. the spherical head 1 and the spherical seat 2, into which the spherical head 1 is inserted under pressure. This inserting of the spherical head 1 is possible in a manner known per se thereby that the spherical seat 2 is provided with juxtaposed slots 5 which widen upon insertion of the spherical head 1 and, thereby, enable the pressure insertion of the spherical head 1 into the spherical seat 2. After inserting the spherical head 1, the spherical seat 2 snaps in behind the spherical head 1 whereby the spherical head 1 is securely held in the spherical seat 2. The spherical heat 2 holds the spherical head 1 by means of an interior surface adapted to the spherical head 1 which interior surface fittingly surrounds the spherical head 1.

FIG. 2 shows, furthermore, two protrusions 6 and 6′ provided at the spherical seat 2 which protrusion protrude from the spherical seat 2. The through hole 4 with its two recesses 8 and 9 is adapted to this arrangement of the spherical seat 2 such that the spherical seat 2 with its two protrusions 6 and 6′ may be inserted into the wall 3, where, therein, the annular bead engages the wall 3, where the two protrusions 6 and 6′ have moved through the recesses 8 and 9 and are juxtaposed to the back side 10 of the wall 3 in their final position.

FIG. 3 shows the spherical seat 2 with inserted spherical head 1 in the position described above, with respect to the wall 3.

Finally, FIG. 4 shows the final position of the combination of the spherical head 1 and the spherical seat 2 in which the spherical seat 2 is shown rotated with respect to the position of FIG. 3, where the protrusions 6 and 6′ have now reach the position in which they engage the back side 10 of the wall 3 practically without play, such that the connection of the spherical head 1 and the spherical seat 2 cannot be removed from the wall 3 anymore.

The position of the spherical seat 2 as shown in the FIGS. 3 and 4, is circumferentially engaged in the area next to the annular bead 7 by the circular part of the through hole 4 practically without play such that a widening of the spherical seat 2 because of the engagement of the spherical seat 2 on the surface of the through hole 3 is avoided in this position whereby the spherical head cannot be removed anymore from the spherical seat 2 and, thereby, from the wall 3.

Upon inserting the spherical seat 2 into the through hole 4 and rotation of the spherical seat 2 in the through hole 4, two locking effects take place at the same time, i.e., at the one hand, the locking of the spherical head 1 which, because of lack of the possibility of widening of the spherical seat, cannot be removed there from anymore, and the locking of the spherical seat 2 itself on the wall 3 by means of its rotation with respect to the mounting position of FIG. 3 since the arms 6 and 6′ resching behind the back side of the wall 3 prevent a removal of the spherical seat 2 from the wall 3.

1. (canceled)

2. Headlight fixture for motor vehicles having an adjustment device comprising a ball joint comprising
a spherical head for selective headlight adjustment and
a spherical seat held in a wall which seat is provided for inserting the spherical head with expandable slots, wherein
the spherical seat comprises, at the one hand, a diameter which fits into a through hole in the wall and, on the other hand, is provided with two juxtaposed protrusions which fit into corresponding recesses at the through hole and seat themselves behind the wall upon rotation of the inserted spherical seat and, thereby, avoid the removal of the spherical seat from the wall.
